(19) United States
(12) Patent Application Publication
(10) Pub. No.: US 2005/0114207 A1
(43) Pub. Date: May 26, 2005

(54) Method, system, and storage medium for filtering content presented on a computer system

(75) Inventor: Frank L. Jania, Chapel Hill, NC (US)

Correspondence Address: CANTOR COLBURN, LLP, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 10/723,056

(22) Filed: Nov. 25, 2003

(51) Int. Cl. G06F 17/60

(52) U.S. Cl. 705/14

(57) ABSTRACT

An exemplary embodiment of the invention relates to a method, system, and storage medium for filtering content presented on a computer system. The method includes selecting an application associated with the computer, selecting a priority level for the application, and selecting at least one mode of presentment relating to the priority level. The mode of presentment is used to handle the manner in which content is presented on the computer. The method also includes storing selections made relating to the application, priority level, and the mode of presentment. The invention also includes a system and a storage medium.

### BACKGROUND OF INVENTION

The present invention relates generally to data processing activities and, more particularly, to a method, system, and storage medium for filtering content presented on a computer system.

Increasingly, computer users are being bombarded with electronic content in a variety of forms. In addition to the exchange of personal communications, for example, electronic messaging is increasingly becoming a popular tool for marketing as well. This is largely due to its convenience, ease of use, and low implementation costs. As a result, many users have been inundated with junk email, advertising, and other unwanted materials, which are often presented in extremely invasive ways. A large amount of unsolicited email can slow down a user's processor, consume a great deal of memory, and distract the user from the important content. Pop-up advertisements are on the increase as more and more individuals utilize the Internet for business, personal, and academic uses. These can also be very distracting to a user who must close out or minimize the advertisement windows as they appear in the forefront of the user's screen, blocking relevant content from the user's view. However, not all messages and advertisements may be irrelevant to a system user. In fact, some may be welcome depending upon the topic, subject matter, or originator of the message/advertisement. In these instances, the user manually filters through the sea of materials presented and individually determines which are relevant. Certainly, this can be a very time-consuming and tedious task.

Accordingly, it would be desirable to be able to prioritize content such as messages, advertisements, and other materials, according to a user's interests and present the content in a manner chosen by the user.

### SUMMARY OF INVENTION

The foregoing discussed drawbacks and deficiencies of the prior art are overcome or alleviated by a method, system, and storage medium for filtering content presented on a computer system. The method includes selecting an application associated with the computer, selecting a priority level for the application, and selecting at least one mode of presentment relating to the priority level. The mode of presentment is used to handle the manner in which content is presented on the computer. The method also includes storing selections made relating to the application, priority level, and the mode of presentment.

An exemplary embodiment of the invention also includes a system for filtering content presented on a computer system. The system includes at least one application executing on the computer system and an interface profile system executing on the computer system. The interface profile system includes an index logic component and an evaluation logic component. The system further includes a personal data index. The interface profile system selects the application, sets a priority level for the application, and selects at least one mode of presentment relating to the priority level. The mode of presentment is used for determining how to handle content presented on the computer. The interface profile system also stores selections made relating to the application, the priority level, and the mode of presentment. Embodiments of the invention also include a storage medium.

### BRIEF DESCRIPTION OF DRAWINGS

Referring to the exemplary drawings wherein like elements are numbered alike in the several FIGURES:

FIG. 1 is a block diagram of a system upon which the interface profile system is implemented in accordance with an exemplary embodiment of the invention;

FIG. 2 is a flowchart describing a process of establishing profile preferences by a user of the interface profile system in accordance with a further aspect of the invention;

FIG. 3 is a flowchart describing a process of handling an advertisement presented on a computer screen in accordance with preferences selected by a user of the interface profile system in exemplary embodiments of the invention;

FIG. 4 illustrates a sample computer screen window presented by the user interface system for use in establishing preferences for a web browser application in an exemplary embodiment of the invention;

FIG. 5 illustrates a sample computer screen window presented by the user interface system for use in establishing preferences for an instant messaging application in an exemplary embodiment of the invention; and

FIG. 6 illustrates a sample computer screen window presented by the user interface system for use in establishing preferences for an email application in an exemplary embodiment of the invention.

### DETAILED DESCRIPTION

Disclosed herein is a method, system, and storage medium for providing a customized user interface for a computer. The interface profile system enables email messages, web advertisements, and similar materials derived from a variety of applications to be filtered based upon priorities established by a user of the system. As used herein, the process of filtering content refers to examining any content received or accessed by a computer user (e.g., messages, documents, web pages, multi-media, etc.) and determining which content items are relevant by comparing them to previous activities conducted by a user and performing analysis on the data. The filtering process also refers to the manner in which the interface profile system handles the content (e.g., in accordance with the results of the analysis as well as in conjunction with preferences selected by the user). The preferences are selected by the user via a user interface of the interface profile system, which include specifying one or more ways in which the content is to be displayed or presented.

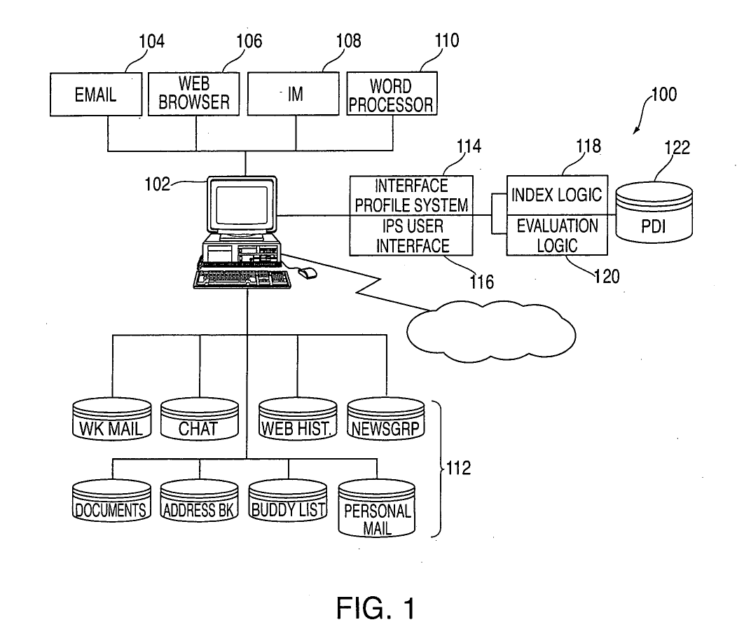

Referring initially to FIG. 1, there is shown a block diagram of a network system for implementing the interface profile system. Network system 100 includes a computer client system 102 in communication with a network such as the Internet.

Computer client system 102 may be a general-purpose desktop computer that subscribes to an Internet service provider and includes operating system software, an email application 104, web browser 106, instant messaging application 108, a word processor application 110, and any other suitable programs that reside in memory and execute on computer client system 102. It will be understood by those skilled in the art that the interface profile system of the invention may be executed on computer systems with variant architectures.

Computer client system 102 receives email messages and instant messages from third parties via the network and may also access web pages, subscribe to a newsgroup, chat group, or other similar community.

Client system 102 stores a variety of data 112 relating to the activities conducted on the client system. This data is saved and utilized by the interface profile system 114 as described further herein. Data 112 may include business email, chat room messages, web browsing histories, newsgroup activities, documents created and/or received, address books, buddy lists, and personal mail, to name a few.

Client system 102 executes the interface profile system 114. In an alternate embodiment, client system 102 shares execution of the interface profile system with a third party service such as an Internet service provider or application service provider.

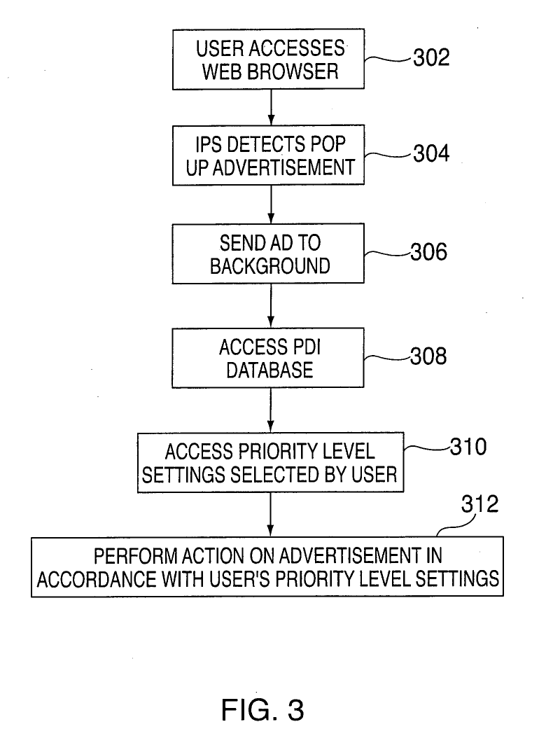

Interface profile system 114 further comprises a graphical user interface 116 for enabling a user of computer client system 102 to view and respond to relevant messaging, advertising, or other content, as well as to provide criteria for defining relevance factors for association with incoming messages, advertising, etc., as desired. Sample computer screen 300 of FIG. 3 illustrates the features of the interface profile system graphical user interface 116.

Interface profile system 114 includes index logic capabilities 118 and evaluation logic capabilities 120. Index logic refers to the gathering of the user's data 112 and organizing it for future reference and analysis. This logic may be performed by software such as a data mining application. The index logic sorts through the data relating to activities performed by the user as well as information received by the user from external sources. Once the data 112 is classified, it is stored in a personal data index 122 and may be referenced by the interface profile system 114 for any of applications 104-110 as needed. Evaluation logic refers to the analysis of the data 112 against the content (e.g., messages, advertisements, etc.) accessed or received by the user. An analytic engine utilizing an algorithm may be used to perform these analyses of the data. The analytic engine reads the content of the messages, documents, advertisements, etc., and compares the content with data stored in the user's personal data index 122. The analysis performed may use criteria such as the nature and frequency of words or subject matter that occur in these content materials or may use criteria identified by the user as described further herein. Analysis occurs whenever a user performs an action on the computer client 102 such as data input, web browsing, business transactions, etc.

As indicated above, the interface profile system 110 may be executed as a standalone application that is installed or downloaded on computer client system 102 or may be incorporated into an existing application such as an operating system as an enhancement feature. Further, as indicated above, the features of the interface profile system 110 may be provided via a third party application service provider (ASP) or e-utilities broker where service is provided for a per-use fee. In a preferred embodiment, the interface profile system 114 is executing simultaneously, and in conjunction with, specific applications running on a computer system

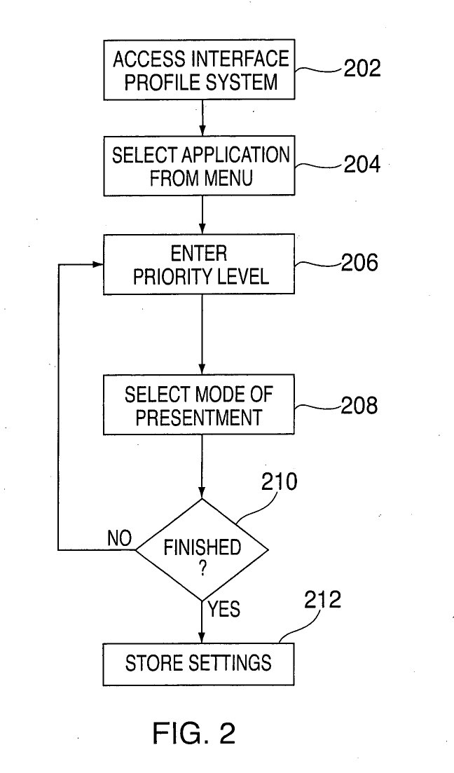

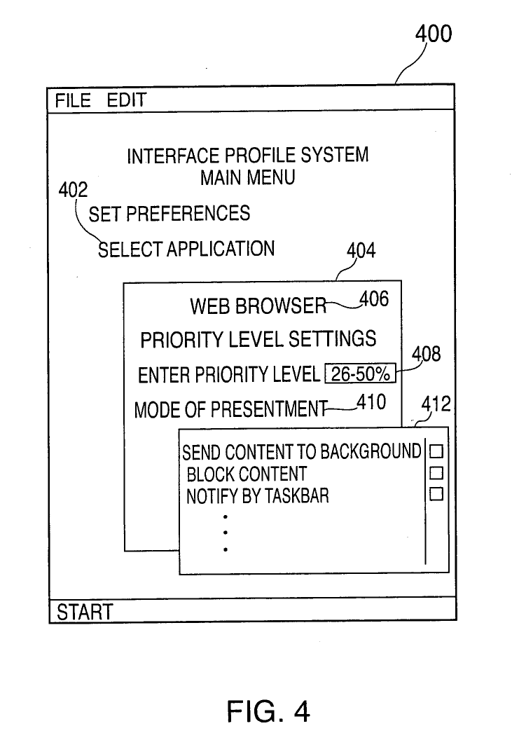

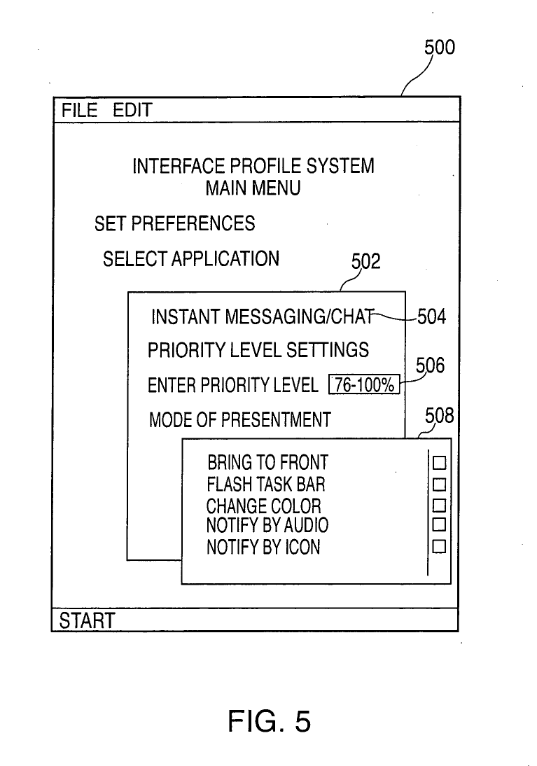

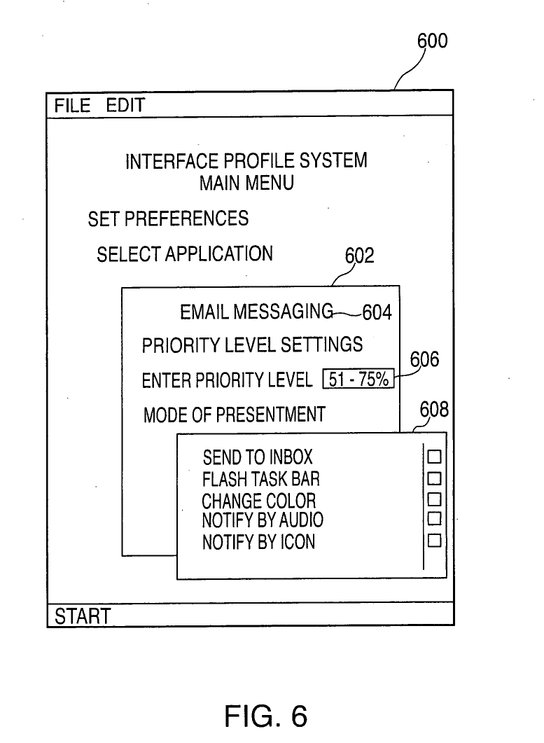

FIG. 2 is a flowchart describing the process of establishing preferences used by the interface profile system 114 in determining priority of various content presented to a user. A user accesses the interface profile system user interface 116 at step 202. A main menu appears as shown generally in FIGS. 4-6. The user is prompted to select an application for establishing preferences at step 204. The user interface system 114 may be utilized for any application executing on the user's computer. Once the application has been determined, the user is prompted to enter a priority level at step 206. The priority level field is shown in FIGS. 4-6 at 408, 506, and 606. The sample priority levels shown in FIGS. 4-6 indicate that the levels are broken down into four 25-percentile groups; however, any type of grouping is contemplated by the interface profile system. The groupings as shown are for illustrative purposes only and are not to be construed as limiting in scope.

Once the priority level has been selected, a sub-window is presented as shown in FIGS. 4-6 at boxes 412, 508, and 608. The subwindows 412, 508, and 608 are presented to the user for selecting the mode in which the user would like to be presented with the content. The elements listed in a subwindow are tailored to the specific application that the user is requesting preference settings to be established. For example, the elements or options provided in subwindow 408 are directed to a web browser application. If the first option, ‘send content to background’ is selected, this indicates that the advertisement or web page that is determined to fall within the priority level of 26-50% will be sent to the background of the user's computer screen. The interface profile system 114, as indicated above, determines what priority is assigned to this content by evaluating the past activities conducted by the user as reflected in the personal data index 122.

At step 210 it is determined whether the user has completed the preferences selections. The user is finished when all priority levels have been addressed by the user, or alternatively, a default may be implemented for those levels not addressed by the user. If the preferences have all been addressed at step 210, the selected settings are stored by the interface profile system 114. Otherwise, the process reverts to step 206 whereby the user is prompted to select another priority level.

As indicated above, the interface profile system handles the content presented on a computer system in accordance with user preferences. FIG. 3 describes a process implemented by the user interface system 114 when an advertisement has been received on a user's web browser application. At step 302, a user accesses a web browser application 106 for which preferences have been previously selected and stored. The interface profile system 114 receives a signal that a pop-up advertisement has been transmitted by the host web site accessed by the user at step 304. The advertisement is temporarily sent to the background of the client system 102 screen at step 306. During this process, any additional advertisements that may be transmitted by the host system are sent to the background as well. The interface profile system 114 accesses the user's personal data index 122 at step 308. The activities conducted by the user are reviewed for relevance by evaluation logic engine 120. The interface profile system 114 then accesses priority level settings previously selected by the user at step 310. These may also be stored in personal data index 122 or similar storage location. Using the settings selected by the user, as well as the relevance assigned to the content, the interface profile system 114 performs an action on the content in accordance with the user's preferences and associated relevance factors at step 312.

The action performed at step 312 may vary according to the priority levels assigned and the mode of presentment selected by the user. The interface profile system provides a variety of features that are selectable by the user in determining the mode of presentment. As indicated above, the mode of presentment may differ among applications. The subwindows 412, 508, and 608 provide a sampling of the modes of presentment available to a user. For example, where a high priority (e.g., 76%-100%) level is set for a web browser application, the browser content may be immediately displayed to the user in the forefront of the user's computer screen, or a symbol or icon may be flashed in an area on the computer screen that is reserved by an operating system for user notifications. Flashing an icon within a portion of the user's computer screen provides a less intrusive means of notification. In another example, where a low priority is (e.g., 0%-25%) level is set for an email application, notification of an incoming message may include sending the email to the user's inbox with no additional action taken, blocking or deleting the message altogether, distinguishing the message from more important messages by changing the color, font, texture, or overall appearance of the email as it is sent to the inbox. Further, the lower priority email messages may be distinguished from higher priority messages by physically segregating them in the inbox (e.g., low priority messages are sent to the bottom of the inbox with a space between the high level messages and the low level messages). Notification of a higher priority level message may be presented by signaling the user with an audio signal, a visual signal such as an icon on the computer screen, or other types of instant notification means. It will also be understood that a combination of these presentment elements in subwindows 412, 508, and 608 may be selected if desired by the user. Thus, for example, a user may wish to change the color of high priority messages as well as flash an icon of the incoming message on the user's computer screen. Additionally, many of these means of presentment may apply to instant messaging applications as well.

As will be appreciated from the above description, the restrictions and limitations that exist with traditional user interfaces systems and services are efficiently overcome. The interface profile system of the invention minimizes the burden of sifting through large quantities of messages, advertisements, and similar content and evaluates the relevance of the various content items on behalf of the user, and presenting or blocking the items in a manner consistent with the user's interests.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for filtering content presented on a computer, comprising:
selecting an application associated with said computer;
selecting a priority level for said application;
selecting at least one mode of presentment relating to said priority level, said mode of presentment operable for handling content presented on said computer via said application;
storing selections made relating to said application, priority level, and said at least one mode of presentment.

2. The method of claim 1, further comprising:
indexing data relating to activities previously conducted on said computer system;
storing indexed data in a database;
upon receiving content associated with activities currently conducted on said computer system, accessing said indexed data from said database;
accessing said selections relating to said application, priority level, and said at least one mode of presentment;
comparing said content with said selections, resulting in a relevance determination;
performing an action on said content in accordance with said relevance determination and said settings.

3. The method of claim 1, wherein said application includes at least one of:
a messaging application;
a web browser application; and
a word processing application.

4. The method of claim 1, wherein said content comprises at least one of:
a web page;
an advertisement;
an email;
an instant message; and
a document.

5. The method of claim 1, wherein said at least one mode of presentment includes at least one of:
blocking said content;
deleting said content;
sending said content to a background screen of said computer system; and
storing said content.

6. The method of claim 1, wherein said at least one mode of presentment includes at least one of:
changing an appearance of said content;
sending an audio signal to said user at said computer system; and
flashing a notification of an incoming message on said computer screen.

7. The method of claim 6, wherein said changing an appearance of said content further includes changing at least one of:
a color;
a font;
a texture; and
a highlight.

8. A storage medium encoded with machine-readable computer program code for filtering content presented on a computer, said storage medium including machine readable computer program code for causing a computer to implement a method, comprising:
selecting an application associated with said computer;
selecting a priority level for said application;
selecting at least one mode of presentment relating to said priority level, said mode of presentment operable for handling content presented on said computer via said application;
storing selections made relating to said application, priority level, and said at least one mode of presentment.

9. The storage medium of claim 8, further comprising instructions for causing said computer to implement:
indexing data relating to activities previously conducted on said computer system;
storing indexed data in a database;
upon receiving content associated with activities currently conducted on said computer system, accessing said indexed data from said database;
accessing said selections relating to said application, priority level, and said at least one mode of presentment;
comparing said content with said selections, resulting in a relevance determination;
performing an action on said content in accordance with said relevance determination and said settings.

10. The storage medium of claim 8, wherein said application includes at least one of:
a messaging application;
a web browser application; and
a word processing application.

11. The storage medium of claim 8, wherein said content comprises at least one of:
a web page;
an advertisement;
an email;
an instant message; and
a document.

12. The storage medium of claim 8, wherein said at least one mode of presentment includes at least one of:
blocking said content;
deleting said content;
sending said content to a background screen of said computer system; and
storing said content.

13. The storage medium of claim 8, wherein said at least one mode of presentment includes at least one of:
changing an appearance of said content;
sending an audio signal to said user at said computer system; and
flashing a notification of an incoming message on said computer screen.

14. The storage medium of claim 13, wherein said changing an appearance of said content further includes changing at least one of:
a color;
a font;
a texture; and
a highlight.

15. A system for filtering content presented on a computer system, said computer system in communication with a communication network, said system comprising:
at least one application executing on said computer system;
an interface profile system executing on said computer system, said interface profile system including an index logic component and an evaluation logic component; and
a personal data index;
wherein said interface profile system performs:
selecting said at least one application;
setting a priority level for said at least one application;
selecting at least one mode of presentment relating to said priority level, said mode of presentment operable for handling content presented on said computer via said application; and
storing selections made relating to said at least one application, said priority level, and said at least one mode of presentment.

16. The system of claim 15, wherein said interface profile system further performs:
indexing data relating to activities previously conducted on said computer system;
storing indexed data in a database;
upon receiving content associated with activities currently conducted on said computer system, accessing said indexed data from said database;
accessing said selections relating to said at least one application, priority level, and said at least one mode of presentment;
comparing said content with said selections, resulting in a relevance determination;
performing an action on said content in accordance with said relevance determination and said settings.

17. The system of claim 15, wherein said application includes at least one of:
a messaging application;
a web browser application; and
a word processing application.

18. The system of claim 15, wherein said content comprises at least one of:
a web page;
an advertisement;
an email;
an instant message; and
a document.

19. The system of claim 15, wherein said at least one mode of presentment includes at least one of:
blocking said content;
deleting said content;
sending said content to a background screen of said computer system; and
storing said content.

20. The system of claim 15, wherein said at least one mode of presentment includes at least one of:
changing an appearance of said content;
sending an audio signal to said user at said computer system; and
flashing a notification of an incoming message on said computer screen.

21. The system of claim 20, wherein said changing an appearance of said content further includes changing at least one of:
a color;
a font;
a texture; and
a highlight.
